(19) United States
(12) Patent Application Publication
(10) Pub. No.: US 2006/0227565 A1
(43) Pub. Date: Oct. 12, 2006

(54) Headlamp gasket

(75) Inventors: Jason Nantais, Royal Oak, MI (US); Satoshi Komiya, West Bloomfield, MI (US)

Correspondence Address: GLOBAL IP COUNSELORS, LLP, 1233 20TH STREET, NW, SUITE 700, WASHINGTON, DC, 20036-2680, US

(73) Assignee: Nissan Technical Center North America, Inc., Farmington Hills, MI (US)

(21) Appl. No.: 11/094,417

(22) Filed: Mar. 31, 2005

(51) Int. Cl. B60Q 1/00

(52) U.S. Cl. 362/507

(57) ABSTRACT

A headlamp gasket is adapted to be disposed between a vehicle exterior body panel and a headlamp housing. The headlamp gasket comprises a base portion and a resilient lip portion. The base portion is configured and arranged to be fixedly coupled to the headlamp housing. The resilient lip portion extends from the base portion to a free end. The lip portion is configured and arranged to bend at a consistent bending position throughout a longitudinal length of the lip portion upon engagement with the vehicle exterior body panel to accommodate spacing variations between the headlamp housing and the vehicle exterior body panel.

### BACKGROUND OF THE INVENTION

1. Field of the Invention

The present invention generally relates to a headlamp gasket for a vehicle. More specifically, the present invention relates to a headlamp gasket disposed between a headlamp housing and a vehicle exterior body panel such as a fender panel.

2. Background Information

In a conventional headlamp mounting structure, a headlamp housing of a modular type headlamp assembly is inserted in a headlamp receiving section formed in a vehicle exterior body panel (e.g., a fender panel) from a front side of the vehicle during assembly. In such conventional headlamp mounting structure, a headlamp gasket is sometimes disposed between the headlamp housing and the fender panel, which acts as an interface between the headlamp housing and the fender panel. A conventional headlamp gasket used in such headlamp mounting structure comprises a base portion fixedly coupled to a peripheral surface of the headlamp housing and a resilient lip portion extending from the base portion. The lip portion extends throughout a longitudinal length of the headlamp gasket that engages with the headlamp receiving section of the fender panel. The lip portion of the conventional headlamp gasket is formed with a substantially uniform transverse thickness from the base portion to a free end of the headlamp gasket. Therefore, during assembly of the headlamp mounting structure, the lip portion of the headlamp gasket bends toward an outer side of the vehicle upon engagement with an edge of the headlamp receiving section of the fender panel as the headlamp housing is installed in the headlamp receiving section of the fender panel.

However, since the lip portion of the conventional headlamp gasket is arranged to have the substantially uniform transverse thickness from the base portion to the free end, bending position and bending amount of the lip portion upon contacting the edge of the headlamp receiving section of the fender panel vary depending on a positional relationship between the headlamp housing and the fender panel. In other words, assembly variations in the positional relationship between the headlamp housing and the fender panel cause the amount of contact between the lip portion of the headlamp gasket and the edge of the headlamp receiving section of the fender panel to change. Thus, in the worst-case assembly condition where the assembly variation is a maximum amount, the lip portion of the headlamp gasket may be bended such that an excessive interference between the lip portion and the fender panel occurs. Since the assembly variations between the fender panel and the headlamp housing can occur along a rim or edge of the fender receiving section of the fender panel, such assembly variations cause variations in the bending position and the bending amount of the lip portion of the headlamp gasket along the edge of the headlamp receiving section the fender panel. As a result, such variations in the bending position and the bending amount of the lip portion result in an inconsistency in the appearance along the edge of the headlamp receiving section of the fender panel.

In view of the above, it will be apparent to those skilled in the art from this disclosure that there exists a need for an improved headlamp gasket. This invention addresses this need in the art as well as other needs, which will become apparent to those skilled in the art from this disclosure.

### SUMMARY OF THE INVENTION

One object of the present invention is to provide a headlamp gasket that is configured and arranged to maintain a substantially consistent appearance along the edge of the fender regardless of the assembly variations between the headlamp housing and the fender panel.

In order to achieve the above object and other objects of the present invention, a headlamp gasket is provided that is adapted to be disposed between a vehicle exterior body panel and a headlamp housing. The headlamp gasket basically comprises a base portion and a resilient lip portion. The base portion is configured and arranged to be fixedly coupled to the headlamp housing. The resilient lip portion extends from the base portion to a free end. The lip portion is configured and arranged to bend at a consistent bending position throughout a longitudinal length of the lip portion upon engagement with the vehicle exterior body panel to accommodate spacing variations between the headlamp housing and the vehicle exterior body panel.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is an overall perspective view of a vehicle in which a headlamp gasket is utilized in a headlamp mounting structure in accordance with a preferred embodiment of the present invention;

FIG. 2 is a partial enlarged perspective view of the headlamp mounting structure with the headlamp gasket in accordance with the preferred embodiment of the present invention;

FIG. 3 is a diagrammatic exploded view of a headlamp housing, a fender panel, and a front end module of the headlamp mounting structure in accordance with the preferred embodiment of the present invention;

FIG. 4 is an exploded view of the headlamp gasket and a headlamp housing including a front cover member and a rear cover member in accordance with the preferred embodiment of the present invention;

FIG. 5 is a schematic perspective view of mating sections formed on the headlamp gasket and the front cover member of the headlamp housing in accordance with the preferred embodiment of the present invention;

FIG. 6 is an enlarged cross sectional view of an fender engagement section of the headlamp gasket in accordance with the preferred embodiment of the present invention as take along a section line 6-6 in FIG. 4;

FIG. 7 is an enlarged cross sectional view of a hood engagement section of the headlamp gasket in accordance with the preferred embodiment of the present invention as taken along a section line 7-7 in FIG. 4;

FIG. 8 is an enlarged cross sectional view of the headlamp mounting structure illustrating a coupling portion between the headlamp housing and the fender panel with the headlamp gasket being disposed therebetween in accordance with the preferred embodiment of the present invention as taken along a section line 8-8 in FIG. 2;

FIG. 9 is a series of diagrams illustrating a process of inserting the headlamp housing with headlamp gasket into a headlamp receiving section of the fender panel in accordance with the preferred embodiment of the present invention; and

FIG. 10 is a schematic cross sectional view of the headlamp mounting structure illustrating assembly variations between the headlamp housing and the fender panel in accordance with the preferred embodiment of the present invention.

### DETAILED DESCRIPTION OF THE PREFERRED EMBODIMENTS

Selected embodiment of the present invention will now be explained with reference to the drawings. It will be apparent to those skilled in the art from this disclosure that the following description of the embodiment of the present invention is provided for illustration only and not for the purpose of limiting the invention as defined by the appended claims and their equivalents.

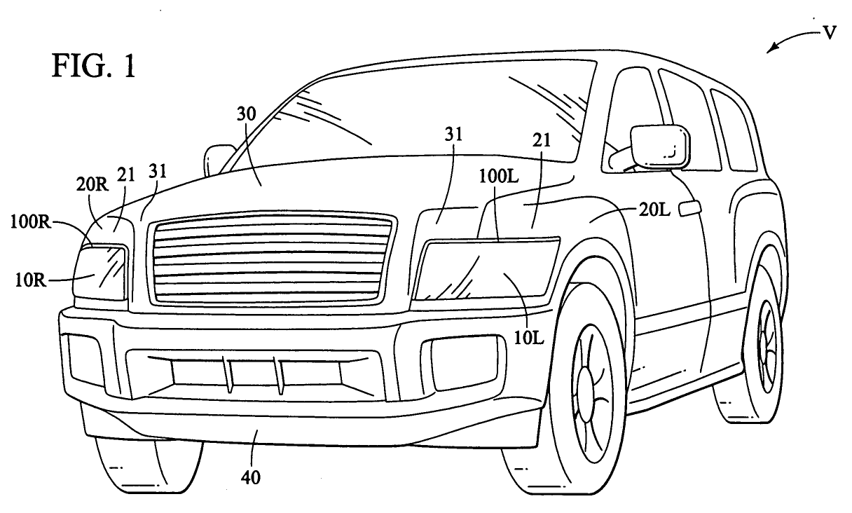

Referring initially to FIG. 1, a front portion of a vehicle V includes a pair of left and right front headlamp housings 10L and 10R installed in left and right ends of the vehicle V, respectively. As seen in FIG. 1, the headlamp housings 10L and 10R are arranged in the vehicle V so that outer portions of the headlamp housings 10L and 10R are disposed adjacent to left and right fender panels 20L and 20R, respectively, while inner portions of the headlamp housings 10L and 10R are disposed adjacent to an engine hood 30. Each of the left and right fender panels 20L and 20R includes a headlamp receiving section 21 that is configured and arranged to conform to an outline of the outer portion of the respective headlamp housing 10L or 10R. The engine hood 30 includes a pair of headlamp mating sections 31 that is configured and arranged to conform to outlines of the inner portions of the headlamp housings 10L and 10R as seen in FIG. 1. A front bumper 40 is disposed below the engine hood 30 and the left and right headlamp housings 10L and 10R.

In the headlamp mounting structure in accordance with the present invention, a left headlamp gasket 100L is provided between the left headlamp housing 10L and the left fender panel 20L and the engine hood 30 as seen in FIG. 1. Similarly, a right headlamp gasket 100R is provided between the right headlamp housing 10R and the right fender panel 20R and the engine hood 30. Since the headlamp mounting structure for the right headlamp housing 10R with the headlamp gasket 100R is identical to the headlamp mounting structure for the left headlamp housing 10L with the headlamp gasket 100L, except that they are the mirror images of each other, only the headlamp mounting structure for the left headlamp housing 10L using the headlamp gasket 100L will be described in detail herein as needed to understand the present invention.

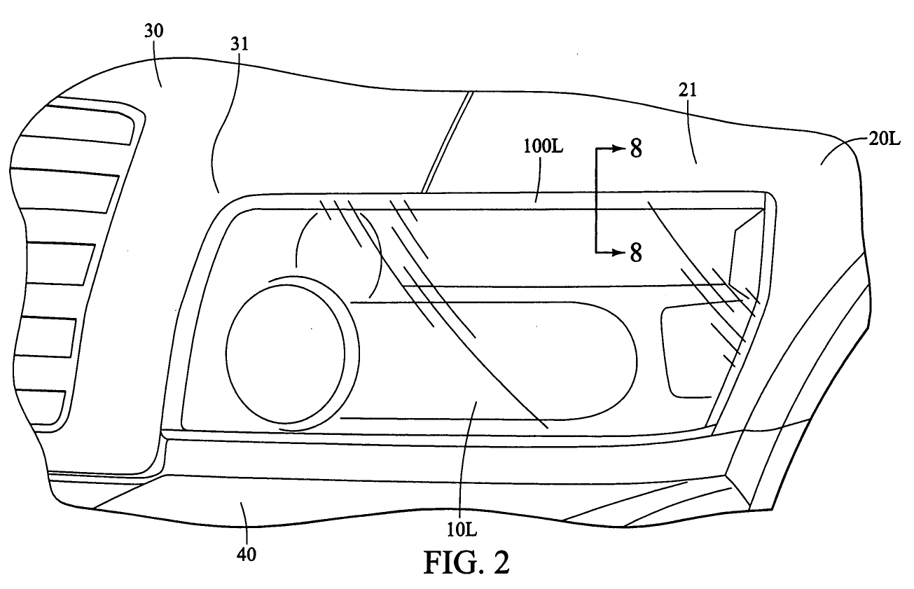

FIG. 2 is a partial enlarged perspective view of the front portion of the vehicle V including the headlamp housing 10L. As seen in FIG. 2, the headlamp gasket 100L extends continuously over the inner side edge and the top edge of the headlamp housing 10L. The headlamp gasket 100L is configured and arranged to form a buffer or interface between the inner side edge of the headlamp housing 10L and the headlamp mating section 31 of the engine hood 30, and between the top edge of the outer portion of the headlamp housing 10L and the headlamp receiving section 21 of the fender panel 20L.

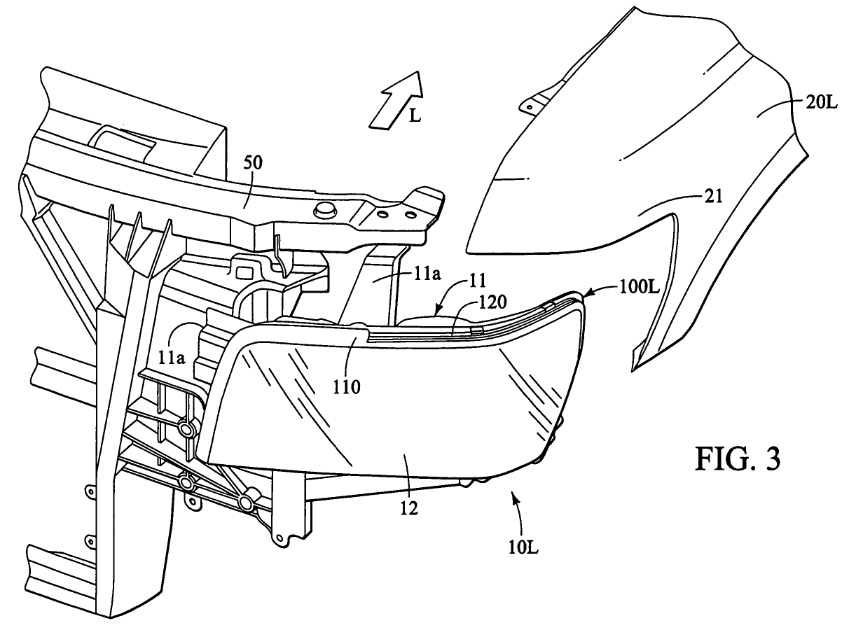

FIG. 3 is an exploded view of the headlamp housing 10L and the fender panel 20L illustrated in FIGS. 1 and 2. FIG. 3 illustrates an assembly state before the headlamp housing 10L is inserted into the headlamp receiving section 21 of the fender panel 20L. As seen in FIG. 3, the headlamp housing 10L is preferably mounted to a front left side of a front end module 50. The front end module 50 is preferably configured and arranged to incorporate a plurality of brackets for various components disposed in the front portion of the vehicle V including the left and right headlamp housings 10L and 10R. After the various components including the left and right headlamp housings 10L and 10R are mounted to the front end module 50, the front end module 50 is fixedly coupled to a vehicle body (not shown), to which the fender panel 20L is mounted. Thus, when the front end module 50 is installed in the vehicle body, the outer portion of the headlamp housing 10L, which is coupled to the front end module 50, is inserted into the headlamp receiving section 21 of the fender panel 20L. More specifically, the headlamp housing 10L is preferably inserted into the headlamp receiving section 21 of the fender panel 20L in a load direction indicated as an arrow L in FIG. 3 (i.e., in a direction from a lower front side of the vehicle V toward an upper rear side of the vehicle V). In the present invention, since the headlamp gasket 100L is provided on the inner side edge and top edge of the headlamp housing 10L, the headlamp gasket 100L is disposed between the top edge of the headlamp housing 10L and the headlamp receiving section 21 of the fender panel 20L as the headlamp housing 10L is inserted into the headlamp receiving section 21.

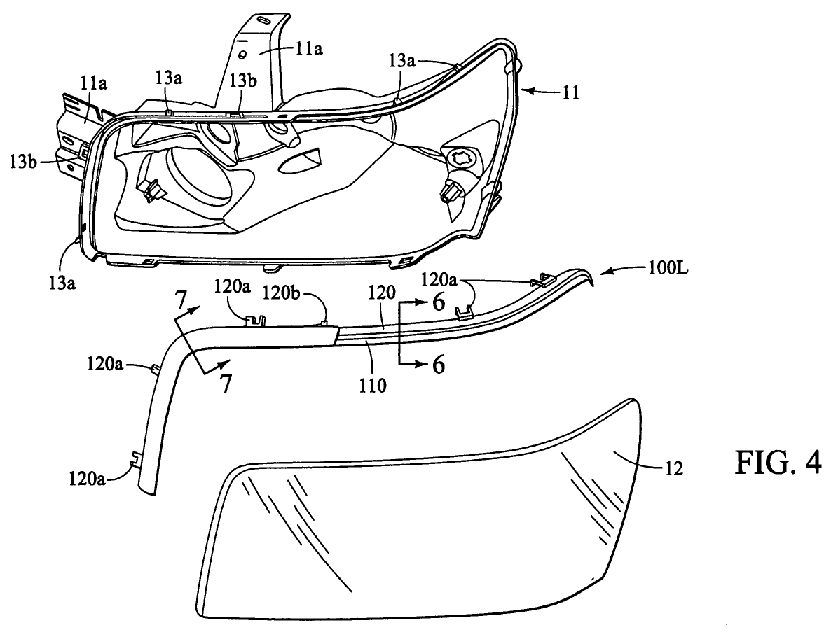

As seen in FIG. 4, the headlamp housing 10L basically comprises a rear cover member 11 and a front cover member 12 so that various components of the headlamp assembly (e.g., light bulbs, reflector and the like) are retained within a substantially enclosed space formed between the rear cover member 11 and the front cover member 12. The rear cover member 11 of the headlamp housing 10L includes a mounting structure 11a that is configured and arranged to be fixedly coupled to the front end module 50 as shown in FIG. 3.

The headlamp gasket 100L is basically divided into a fender engagement section that is configured and arranged to interface between the fender panel 20L and the headlamp housing 10L, and a hood engagement section that is configured and arranged to interface between the engine hood 30 and the headlamp housing 10L. Moreover, the headlamp gasket 100L comprises a resilient member 110 and a plate-shaped mounting member 120 that is integrally formed with the resilient member 110. Both the resilient member 110 and the mounting member 120 are configured and arranged to extend throughout the longitudinal length of the headlamp gasket 100L including the fender engagement section and the hood engagement section. In other words, both of the resilient member 110 and the mounting member 120 are configured and arranged to extend over the inner side edge and the top edge of the headlamp housing 10L as seen in FIG. 4. The resilient member 110 and the plate-shaped mounting member 120 are preferably made of synthetic resins with the resilient member 110 having a lower rigidity than the mounting member 120. For example, the resilient member 110 is preferably made of resilient rubber or the like, and the mounting member 120 is preferably made of hard plastic or the like. More specifically, in this embodiment of the present invention, the resilient member 110 and the plate-shaped mounting member 120 of the headlamp gasket 100L are preferably manufactured by using a two shot molding process in which the mounting member 120 with a higher rigidity is first shot in a molding tool, and then, the resilient member 110 with a lower rigidity is shot on top of the mounting member 120. As a result, the headlamp gasket 100L including the resilient member 110 and the mounting member 120 is formed as a one-piece, unitary member. Thus, there is no need to provide additional attachment structure between the resilient member 110 and the mounting member 120 of the headlamp gasket 100L. Of course, it will be apparent to those skilled in the art from this disclosure that the resilient member 110 and the mounting member 120 can be formed as separate members as long as these members are coupled to or integrated with each other.

The mounting member 120 of the headlamp gasket 100L basically has a uniform cross sectional shape throughout the fender engagement section and the hood engagement section. The mounting member 120 includes a plurality of mating sections 120a and 120b for fixedly mounting the headlamp gasket 100L to the headlamp housing 10L. More specifically, the mating section s 120a and 120b are configured and arranged to snap-fit into a plurality of mating sections 13a and 13b, respectively, formed along the top and inner side edges of the rear cover member 11 of the headlamp housing 10L. Thus, after the headlamp housing 10L is assembled (i.e., after the front cover member 12 is mounted to the rear cover member 11), the headlamp gasket 100L is fixedly coupled to the rear cover member 11 of the headlamp housing 10L by engaging the mating sections 120a and 120b of the mounting member 120 to the mating sections 13a and 13b, respectively, formed on the rear cover member 11 of the headlamp housing 10L. As seen in FIG. 4, in this embodiment of the present invention, the headlamp gasket 100L is preferably provided with a total of six mating sections 120a and 120b (four mating sections 120a and two mating sections 120b) that are spaced apart in the longitudinal direction of the headlamp gasket 100L. Likewise, the rear cover member 11 is preferably provided with a total of six mating sections 13a and 13b (four mating sections 13a and two mating sections 13b) disposed on the inner side edge and the top edge of the rear cover member 11 at positions corresponding to the positions of the mating sections 120a and 120b of the headlamp gasket 100L. Thus, in this embodiment, the headlamp gasket 100L is mounted to the inner side edge and the top edge of the rear cover member 11 at six positions that are spaced apart along the longitudinal length of the headlamp gasket 100L. The number of the positions where the headlamp gasket 100L is mounted to the rear cover member 11 (i.e., the number of the mating members 120a and 120b, and the number of the number of the mating members 13a and 13b) is not limited to six. Rather, the headlamp gasket 100L can be mounted to the rear cover member 11 at any number of positions as long as the headlamp gasket 100L is fixedly coupled to the headlamp housing 10L.

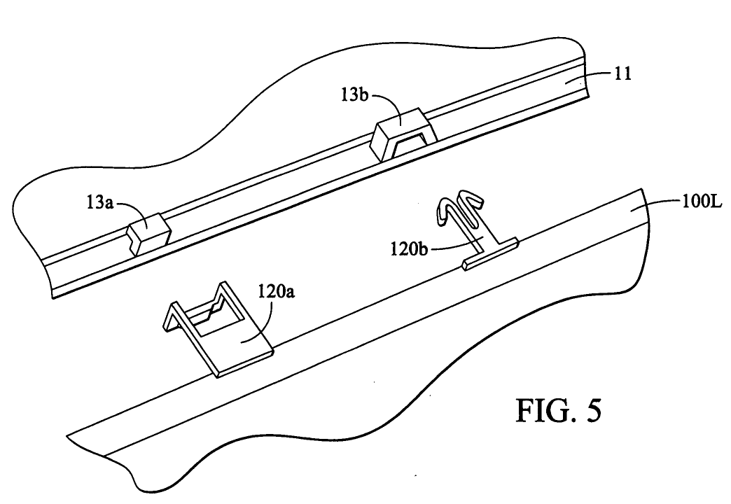

FIG. 5 illustrates examples of structures of the mating sections 120a and 120b of the headlamp gasket 100L and the mating sections 13a and 13b of the rear cover member 11. As seen in FIG. 5, the mating sections 120a and 120b are configured and arranged to snap-fit into the mating sections 13a and 13b, respectively, to fixedly couple the headlamp gasket 100L to the rear cover member 11. Of course, it will be apparent to those skilled in the art from this disclosure that the shapes of the mating sections 120a and 120b, and the mating sections 13a and 13b are not limited to the ones shown in FIG. 5. Moreover, although in the present embodiment, two different shapes of the mating sections 120a and 120b, and the mating sections 13a and 13b are utilized, the mating sections 120a and 120b, and the mating sections 13a and 13b can be arranged to have a uniform shape, or can utilize more than two different shapes.

Furthermore, in addition to the mating sections 120a and 120b formed on the mounting member 120 of the headlamp gasket 100L, an adhesive tape or the like is preferably provided between the bottom surface of the headlamp gasket 100L in the fender engagement section to hold the headlamp gasket 100L in place during installation.

The resilient member 110 of the headlamp gasket 100L is preferably configured and arranged to have different cross sectional shapes in the fender engagement section and in the hood engagement section. However, a cross sectional shape throughout a longitudinal length of the fender engagement section is arranged as being substantially uniform, and a cross sectional shape throughout a longitudinal length of the hood engagement section is arranged as being substantially uniform. Thus, the molding process of the headlamp gasket 100L can be simplified and manufacturability of the headlamp gasket 100L can be improved.

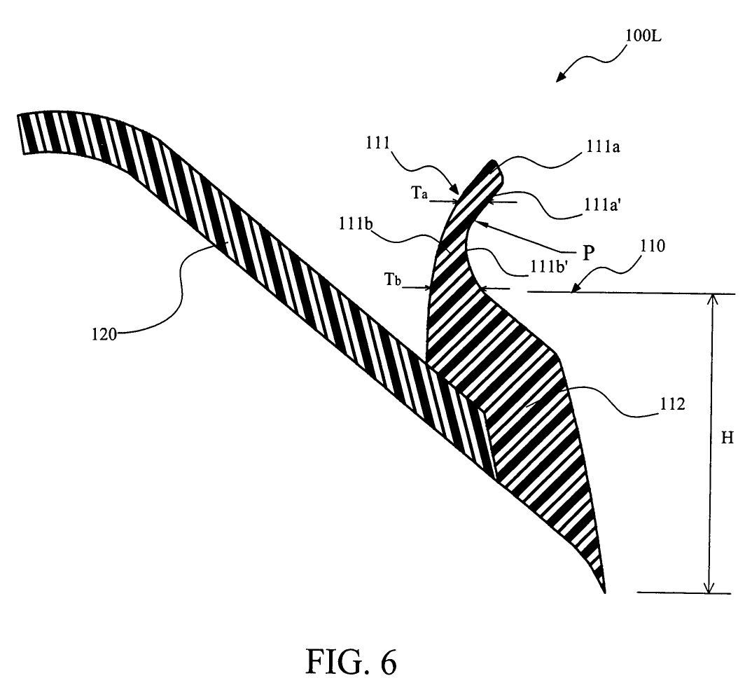

FIG. 6 is a cross sectional view of the fender engagement section of the headlamp gasket 100L as taken along a section line 6-6 in FIG. 4. As seen in FIG. 6, the resilient member 110 in the fender engagement section basically comprises a lip portion 111 and a main body part 112. The main body part 112 together with the mounting member 120 constitutes a base portion of the present invention, which is configured and arranged to be coupled to the rear cover member 11. In other words, the main body part 112 of the resilient member 110 is integrally formed with the mounting member 120. As explained above, the mounting member 120 is configured and arranged to be fixedly coupled to the headlamp housing 10L by snap-fitting the mating sections 120a and 120b of the mounting member 120 with the mating sections 13a and 13b, respectively, formed on the edges of the rear cover member 11. The main body part 112 is configured and arranged to have a prescribed vertical thickness or height H to prevent a interference between the edge of the fender receiving section 21 of the fender panel 20L and the headlamp housing 10L.

As seen in FIG. 6, the lip portion 111 of the resilient member 110 in the fender engagement section extends from the main body part 112 to a free end. The lip portion 111 is configured and arranged to bend at a consistent bending position P throughout a longitudinal length of fender engagement section upon engagement with the edge of the fender receiving section 21 of the fender panel 20L regardless of assembly vibrations between the headlamp housing 10L and the fender panel 20L along a rim or edge of the fender panel 20L. In other words, the lip portion 111 of the headlamp gasket 100L is configured and arranged to accommodate spacing variations between the headlamp housing 10L and the fender panel 20L along the edge of the fender panel 20L.

More specifically, the lip portion 111 includes an end part 111a and a support part 111b as seen in FIG. 6. The end part 111a and the support part 111b are configured and arranged such that the consistent bending position P is disposed at a transitional point between the support part 111b and the end part 111a. The end part 111a of the lip portion has a substantially uniform transverse thickness from the free end to the transitional point between the end part 111a and the support part 111b, while the support part 111b has a transverse thickness that continuously increases toward the main body part 112. More specifically, the support part 111b is configured and arranged such that a local material thickness is gradually increased from the transitional point between the end part 111a and the support part 111b to the main body part 112. Thus, the support part 111b of the lip portion 111 preferably has a maximum thickness T_{b} that is larger than a maximum thickness Tₐ of the end part 111a as measured in a transverse direction of the lip portion 111 as shown in FIG. 6.

Moreover, as seen in FIG. 6, the end part 111a of the lip portion 111 has a substantially planer wall surface 111a′, and the support part 111b of the lip portion 111 has a curved wall surface 111b′ continuously extending from the planer wall surface 111a′ of the end part 111a. The curved wall surface 111b′ of the support part 111b is configured and arranged to form a concave surface between the main body part 112 and the end part 111a as viewed from the front side of the vehicle V when the headlamp gasket 100L is coupled to the headlamp housing 10L. The end part 111a and the support part 111b are preferably arranged such that the planer wall surface 111a′ of the end part 111 forms a tangent line to a radius of curvature of the curved wall surface 111b′ of the support part 111 at the transitional point between the end part 111a and the support part 111b in the transverse cross section of the lip portion 111 as seen in FIG. 6. With this arrangement of the end part 111a and the support part 111b, the transitional point between the end part 111a and the support part 111b forms the consistent bending position P at which the end part 111a of the lip portion 111 bends upon engagement with the edge of the fender receiving section 21 of the fender panel 20L when the headlamp housing 10L is inserted into the fender receiving section 21 of the fender panel 20L. Since the local material thickness of the support part 111b is gradually increased from the transitional point between the end part 111a and the support part 111b toward the main body part 112, the radius of curvature of the curved wall surface 111b′ of the support part 111 is relatively large. Therefore, molding conditions and manufacturability of the headlamp gasket 100L are improved, and wearing of the molding tools can be reduced. Moreover, since the local material thickness is increased in the support part 111b of the lip portion 111, the structural stability can be improved, and the lip portion 111 can be prevented from moving out of a prescribed position when the headlamp gasket 100L is disposed between the headlamp housing 10L and the fender panel 20L.

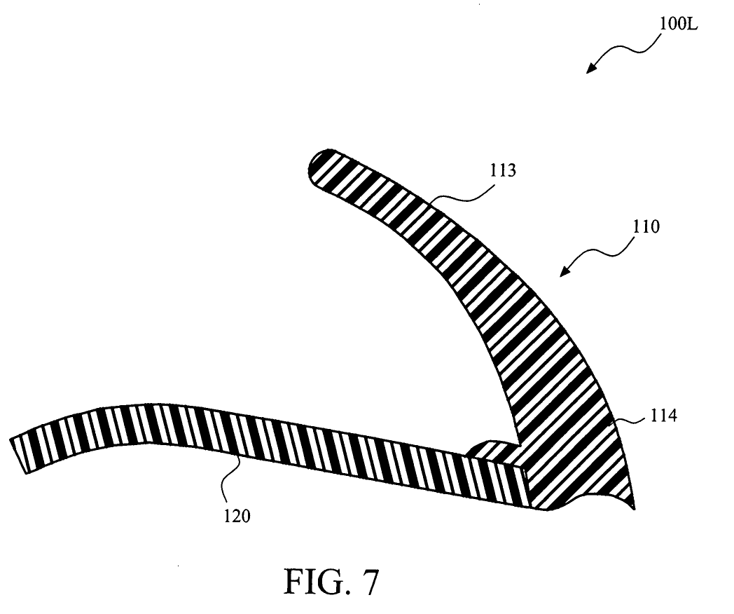

FIG. 7 is a cross sectional view of the headlamp gasket 100L at the hood engagement section as taken along a section line 7-7 in FIG. 4. As seen in FIG. 7, the resilient member 110 in the hood engagement section comprises a lip portion 113 and a main body part 114. The main body part 114 is integrally formed with the mounting member 120 that is configured and arranged to be fixedly coupled to the rear cover member 11 as explained above. The lip portion 113 continuously extends from the main body part 114 in a direction generally parallel to the mounting part 120. Thus, when the headlamp housing 10L with the headlamp gasket 100L being attached is installed in the vehicle V, the lip portion 113 in the hood engagement section of the headlamp gasket 100L extends in a substantially rearward direction of the vehicle V so that the lip portion 113 form a buffer or interface between the headlamp housing 10L and the engine hood 30 when the engine hood 30 is in a closed state.

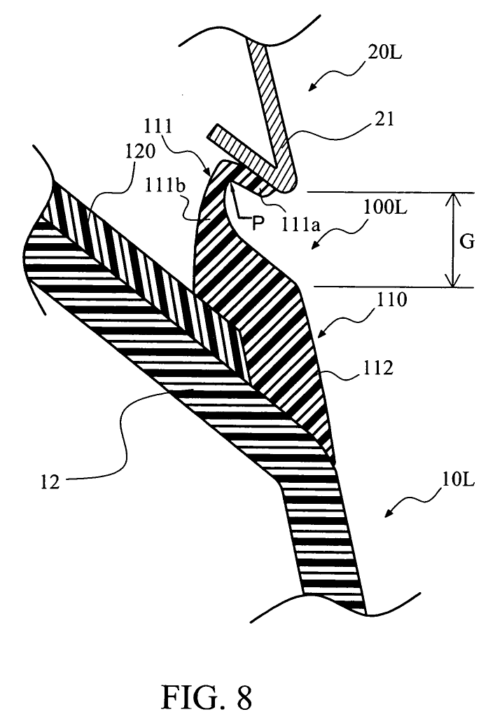

FIG. 8 is a cross sectional view of the headlamp gasket 100L in the fender engagement section as taken along a section line 8-8 in FIG. 2 illustrating when the headlamp housing 10L is installed in the fender panel 20L. As seen in FIG. 8, the headlamp gasket 100L is disposed between the fender panel 20L and the headlamp housing 10L as the lip portion 111 of the headlamp gasket 100L resiliently abuts against the edge of the fender receiving section 21 of the fender panel 21L. More specifically, the lip portion 111 of the resilient member 110 bends at the consistent bending position P so that the end part 111a of the lip portion 111 folds toward the front side of the vehicle V with respect to the support part 111b of the lip portion 111. The fender panel 20L and the headlamp housing 10L are preferably arranged so that a prescribed gap G is formed between the edge of the fender panel 20L and a top surface of the main body part 112 of the headlamp gasket 100L when the headlamp housing 10L is installed in a reference or ideal position with respect to the fender panel 20L. In this embodiment of the present invention, the prescribed gap G is preferably set to approximately 2.5 mm. Of course, it will be apparent to those skilled in the art from this disclosure that a precise measurement of the prescribed gap G varies depending on the structures of the vehicle front portion including the structures of the fender panel and the headlamp housing.

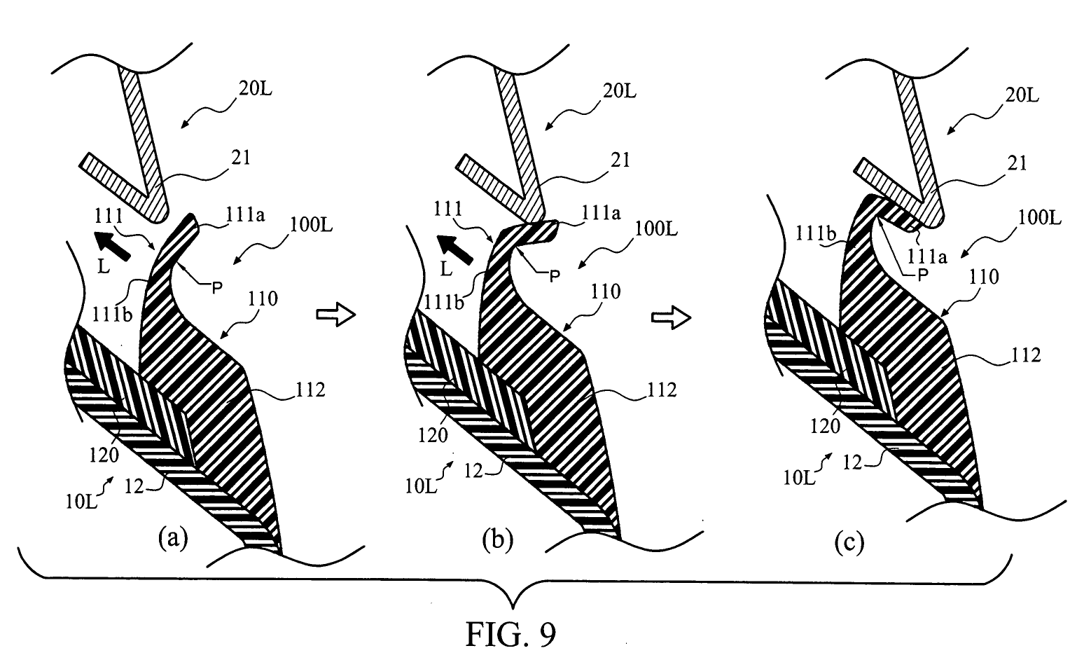

FIG. 9 shows a series of diagrams (a) to (c) for illustrating an installation process when the headlamp housing 10L with the headlamp gasket 100L is inserted into the headlamp receiving section 21 of the fender panel 20L. As seen in the diagram (a) of FIG. 9, the headlamp gasket 100L which is coupled to the headlamp housing 10L is disposed with respect to the fender panel 20L, and moved in the load direction L toward the fender panel 20L. As the lip portion 111 of the headlamp gasket 100L contacts with the edge of the headlamp receiving section 21 of the fender panel 20L (the diagram (b) of FIG. 9), the end part 111a of the lip portion 111 starts folding toward the front side of the vehicle V at the consistent bending position P. Then, the headlamp housing 10L is further moved in the load direction L so that the headlamp housing 10L is installed in the prescribed position with respect to the fender panel 20L. Thus, as seen in the diagram (c) in FIG. 9, when the headlamp housing 10L is disposed in the prescribed position, the headlamp gasket 100L is disposed between the fender panel 20L and the headlamp housing 10L with the end part 111a of the lip portion 111 resiliently engaging with the edge of the headlamp receiving section 21 of the fender panel 20L.

As explained above, the lip portion 111 of the headlamp gasket 100L is configured and arranged to bend at the consistent bending position P. Therefore, even when there are assembly variations between the fender panel 20L and the headlamp housing 10L along the longitudinal length of the fender engagement section of the headlamp gasket 100L, the lip portion 111 readily bends at the consistent bending position P. Thus, the overall appearance of the coupling portion between the fender panel 20L and the headlamp housing 10L becomes consistent along the edge of the fender panel 20L regardless of the assembly variations.

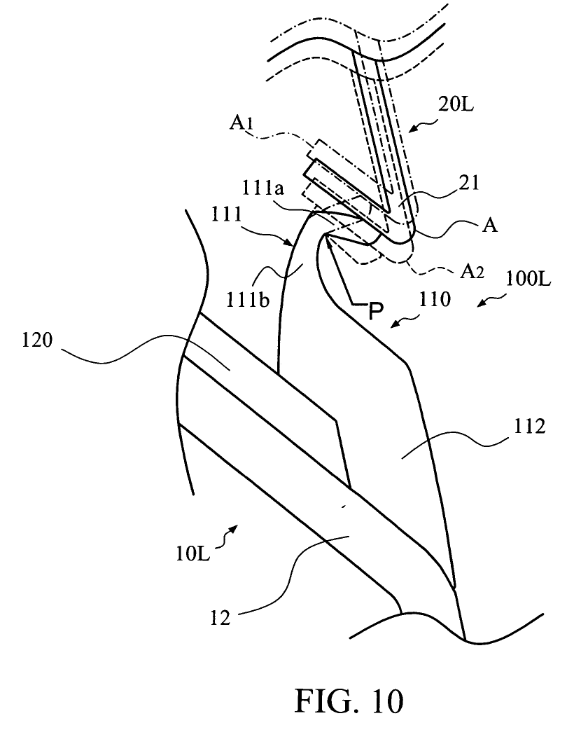

For example, FIG. 10 illustrates examples of assembly variations between the fender panel 20L and the headlamp housing 10L that are indicated in a solid line A, a dash-dot line A₁ and a dashed line A₂. As seen in FIG. 10, the headlamp gasket 100L of the present invention is configured and arranged to bend constantly at the consistent bending position P even when a clearance between the fender panel 20L and the headlamp housing 10L varies due to the assembly variations. Even when the assembly variation causes the clearance between the fender panel 20L and the headlamp housing 10L to be larger (shown in the dash-dot line A₁) or smaller (shown in the dashed line A₂) than the clearance in a reference position (shown in the solid line A), the end part 111a of the lip portion 111 constantly bends at the consistent bending position P as seen in FIG. 10. In other words, the excessive interference between the end part 111a of the lip portion 111 and the edge of the fender panel 20L is avoided even when the assembly variation is a large amount.

More specifically, in the present invention, the headlamp gasket 100L is preferably configured and arranged to include the consistent bending position P that is designed based on the worst-case assembly conditions (e.g., based on a maximum projected clearance and a minimum projected clearance between the edge of the fender panel 20L and the headlamp housing 10L). For example, in this embodiment of the present invention, the projected assembly variations in the worst-case assembly conditions are approximately ±1.8 mm from the reference position. Thus, in this embodiment, the radius of curvature of the curved wall surface 111b′ of the support part 111b and the point at which the local material thickness increases in the support part 111b are determined such that that the lip portion 111 always bends at the consistent bending position P as long as the assembly variation between the edge of the fender panel 20L and the headlamp housing 10L is within a range between ±1.8 mm. Of course, it will be apparent to those skilled in the art from this disclosure that the worst-case assembly conditions (projected assembly variations) vary depending on the structures of a vehicle front portion including the structures of the fender panel and the headlamp housing, and other various considerations. In any event, in the present invention, the end part 111a and the support part 111b of the lip portion 111 are formed to have the consistent bending position P so that the lip portion 111 can accommodate the worst-case assembly variations expected for a particular structure in which the headlamp gasket 100L is utilized.

Accordingly, with the headlamp gasket 100L of the present invention, the assembly variations between the fender panel 20L and the headlamp housing 10L are reliably accommodated. Thus, even when the clearance between the edge of the fender panel 20L and the headlamp housing 10L is not uniform along the edge of the fender panel 20L, an excessive interference between the lip portion 111 of the headlamp gasket 100L and the edge of the fender panel 20L is prevented because the lip portion 111 always bends at the consistent bending position P upon engagement with the edge of the fender panel 20L. As a result, a consistent appearance along the entire edge of the fender panel 20L in the fender engagement section of the headlamp gasket 100L can be obtained regardless of the assembly variations between the between the fender panel 20L and the headlamp housing 10L.

As used herein to describe the above embodiment(s), the following directional terms “forward, rearward, above, downward, vertical, horizontal, below and transverse” as well as any other similar directional terms refer to those directions of a vehicle equipped with the present invention. Accordingly, these terms, as utilized to describe the present invention should be interpreted relative to a vehicle equipped with the present invention.

The terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. A headlamp gasket adapted to be disposed between a vehicle exterior body panel and a headlamp housing, comprising:
a base portion configured and arranged to be fixedly coupled to the headlamp housing; and
a resilient lip portion extending from the base portion to a free end, the lip portion being configured and arranged to bend at a consistent bending position throughout a longitudinal length of the lip portion upon engagement with the vehicle exterior body panel to accommodate spacing variations between the headlamp housing and the vehicle exterior body panel.

2. The headlamp gasket as recited in claim 1, wherein
the lip portion includes an end part and a support part extending between the base portion and the end part such that the consistent bending position is disposed at a transitional point between the support part and the end part.

3. The headlamp gasket as recited in claim 2, wherein
the support part of the lip portion has a maximum thickness that is larger than a maximum thickness of the end part of the lip portion as measured in a transverse direction of the lip portion.

4. The headlamp gasket as recited in claim 2, wherein
the support part of the lip portion has a transverse thickness that continuously increases toward the base portion.

5. The headlamp gasket as recited in claim 4, wherein
the end part of the lip portion has a substantially uniform transverse thickness from the free end to the transitional point between the support part and the end part.

6. The headlamp gasket as recited in claim 2, wherein
the support part of the lip portion has a curved wall surface forming a concave surface between the base portion and the end part, and
the end part of the lip portion has a substantially planer wall surface continuously extending from the curved wall surface of the support part.

7. The headlamp gasket as recited in claim 6, wherein
the end part and the support part of the lip portion are arranged such that the planer wall surface of the end part forms a tangent line to the curved wall surface of the support part at the transitional point between the support part and the end part in a transverse cross section of the lip portion.

8. The headlamp gasket as recited in claim 1, wherein
the lip portion has a substantially uniform cross sectional shape throughout the longitudinal length of the lip portion.

9. The headlamp gasket as recited in claim 1, wherein
the base portion includes a main body part and a plate-shaped mounting part integrally formed with the main body part, the mounting part being configured and arranged to be fixedly coupled to the headlamp housing.

10. The headlamp gasket as recited in claim 1, wherein
the base portion and the lip portion are formed as a one-piece, unitary member.

11. A headlamp mounting structure comprising:
a vehicle exterior body panel with a headlamp receiving section;
a headlamp housing disposed in the headlamp receiving section of the vehicle exterior body panel; and
a headlamp gasket disposed between an edge of the headlamp receiving section of the vehicle exterior body panel and the headlamp housing, the headlamp gasket including
a base portion coupled to the headlamp housing;
a resilient lip portion extending from the base portion toward the vehicle exterior body panel and being bent at a consistent bending position throughout a longitudinal length of the lip portion to accommodate spacing variations between the headlamp housing and the vehicle exterior body panel.

12. The headlamp mounting structure as recited in claim 11, wherein
the lip portion of the headlamp gasket bends at the consistent bending position in a direction toward an outer side of a vehicle.

13. The headlamp mounting structure as recited in claim 11, wherein
the lip portion includes an end part and a support part extending between the base portion and the end part such that the consistent bending position is disposed at a transitional point between the support part and the end part.

14. The headlamp mounting structure as recited in claim 13, wherein
the support part of the lip portion has a maximum thickness that is larger than a maximum thickness of the end part of the lip portion as measured in a transverse direction of the lip portion.

15. The headlamp mounting structure as recited in claim 13, wherein
the support part of the lip portion has a transverse thickness that continuously increases toward the base portion.

16. The headlamp mounting structure as recited in claim 15, wherein
the end part of the lip portion has a substantially uniform transverse thickness from the free end to the transitional point between the support part and the end part.

17. The headlamp mounting structure as recited in claim 13, wherein
the support part of the lip portion has a curved wall surface forming a concave surface facing an outer side of a vehicle between the base portion and the end part, and
the end part of the lip portion has a substantially planer wall surface continuously extending from the curved wall surface of the support part.

18. The headlamp mounting structure as recited in claim 17, wherein
the end part and the support part of the lip portion are arranged such that the planer wall surface of the end part forms a tangent line to the curved wall surface of the support part at the transitional point between the support part and the end part in a transverse cross section of the lip portion before the lip portion is bended.

19. The headlamp mounting structure as recited in claim 11, wherein
the lip portion bends at the consistent bending position upon engagement with the vehicle exterior body panel to accommodate the spacing variations ranging between a minimum projected clearance and a maximum projected clearance between the headlamp housing and the vehicle exterior body panel.

20. The headlamp mounting structure as recited in claim 11, wherein
the base portion includes a main body part and a plate-shaped mounting part integrally formed with the main body part, the mounting part being fixedly coupled to the headlamp housing.

21. The headlamp mounting structure as recited in claim 11, wherein
the headlamp housing is fixedly coupled to a front end module disposed in a front section of a vehicle.
